(19) United States
(12) Patent Application Publication
(10) Pub. No.: US 2024/0384384 A1
(43) Pub. Date: Nov. 21, 2024

(54) METHOD FOR PRODUCING Fe-BASED NANOCRYSTALLINE ALLOY MAGNETIC CORE AND Fe-BASED NANOCRYSTALLINE ALLOY MAGNETIC CORE

(71) Applicant: NIPPON CHEMI-CON CORPORATION, Tokyo (JP)

(72) Inventors: Michiko OIKAWA, Tokyo (JP); Shigeki SHIRASE, Tokyo (JP); Ryo TSUBOI, Tokyo (JP)

(21) Appl. No.: 18/687,271

(22) PCT Filed: Aug. 31, 2022
(86) PCT No.: PCT/JP2022/032815

§ 371 Date: Feb. 27, 2024

(30) Foreign Application Priority Data
Aug. 31, 2021 (JP) 2021-141788

(51) Int. Cl. C23C 8/80; C22C 38/00; C22C 38/02; C22C 38/12; C22C 38/16; C23C 8/10; H01F 1/147

(52) U.S. Cl. CPC C23C 8/80; C22C 38/002; C22C 38/02; C22C 38/12; C22C 38/16; C23C 8/10; H01F 1/14766; C22C 2200/04; C22C 2202/02

(57) ABSTRACT

A method for producing a Fe-based nanocrystalline alloy magnetic core, the method including: an oxide film forming step of subjecting a magnetic core material in which a ribbon of a nanocrystallizable Fe-based alloy is wound to heat treatment under an oxidizing atmosphere; and a nanocrystallizing step of subjecting the magnetic core material that underwent the oxide film forming step to heat treatment under a non-oxidizing atmosphere to perform nanocrystallization of the nanocrystallizable Fe-based alloy; wherein the highest temperature of the heat treatment at the oxide film forming step is a temperature of lower than a crystallization start temperature of the nanocrystallizable Fe-based alloy, and wherein the highest temperature of the heat treatment at the nanocrystallizing step is a temperature of equal to or higher than the crystallization start temperature of the nanocrystallizable Fe-based alloy.

### TECHNICAL FIELD

The present disclosure relates to a method for producing a Fe-based nanocrystalline alloy magnetic core and a Fe-based nanocrystalline alloy magnetic core.

### BACKGROUND ART

A Fe-based nanocrystalline alloy has an excellent soft magnetic characteristic capable of implementing high magnetic permeability, and hence is used for the magnetic core of a common mode choke, a high frequency transformer, or the like.

As the typical composition of the Fe-based nanocrystalline alloy, there is known a magnetic material of a Fe—Si—B—Cu—Nb type nanocrystal including Fe as the main component (Patent Document 1). The coil or the magnetic core using such a magnetic material can be obtained generally by winding of a ribbon of a nanocrystallizable Fe-based amorphous alloy to form a cylindrical wound magnetic core, and then subjecting it to heat treatment.

The magnetic core is required to have higher magnetic permeability, so that, other than selection of the material, the technology of improving the magnetic permeability has been under active development.

For example, Patent Documents 2 and 3 disclose a technology of improving the magnetic permeability of a magnetic core constituted by a wound or stacked ribbon(s) of an amorphous magnetic alloy in the high frequency region, by forming an oxide film on the surface of the magnetic ribbon(s). In this technology, an oxide film has the function of insulating between the ribbon layers of the magnetic core in which a magnetic ribbon(s) is wound or stacked, and thus generation of an eddy current flowing between the ribbon layers is suppressed and the eddy current loss is reduced, resulting in the improvement of the magnetic permeability.

Further, Patent Document 4 discloses the technology of applying a magnetic core using a nanocrystalline alloy material with a magnetic field while subjecting the magnetic core to heat treatment, thereby adjusting the crystalline magnetic anisotropy, for improving the magnetic permeability.

### PRIOR ART DOCUMENT

### Patent Document

Patent Document 1: Japanese Patent Application Publication No. S64-79342

Patent Document 2: Japanese Patent Application Publication No. H6-346219

Patent Document 3: Japanese Patent Application Publication No. S57-169207

Patent Document 4: Japanese Patent Application Publication No. H2-77105

### SUMMARY OF INVENTION

### Technical Problem

In recent years, for example, a magnetic core for common mode choke is required to be also sufficiently adaptable to low frequencies.

Also for a magnetic core in which a nanocrystalline alloy magnetic ribbon(s) is wound or stacked, the formation of an oxide film on the surface of the magnetic ribbon can suppress the generation of an eddy current flowing between the ribbon layers, and can improve the magnetic permeability in the high frequency region. However, with the nanocrystalline alloy magnetic core, as distinct from the amorphous alloy magnetic core as described in Patent Documents 2 and 3, the formation of an oxide film tends to reduce the magnetic permeability in the low frequency region. Also for the nanocrystalline alloy magnetic core, although magnetic field application enables the improvement of the magnetic permeability in the low frequency region, undesirably, the degree of the improvement thereof is still not enough.

In view of the above problem, the present invention is to provide a method for producing a Fe-based nanocrystalline alloy magnetic core having high magnetic permeability in the low frequency region.

### Solution To Problem

The present inventors conducted a close study in order to solve the foregoing problem. As a result, they found the following: an oxide film is formed on the surface of a Fe-based alloy ribbon of a magnetic core material that includes a Fe-based alloy ribbon wound therein; subsequently, the Fe-based alloy is nanocrystallized under environment in which an oxide film is not formed; as a result, a Fe-based nanocrystalline alloy magnetic core having high magnetic permeability also in the low frequency region can be obtained. This led to the present invention. Namely, the present invention has the following gist.

[1] A method for producing a Fe-based nanocrystalline alloy magnetic core, the method comprising:
an oxide film forming step of subjecting a magnetic core material in which a ribbon of a nanocrystallizable Fe-based alloy is wound to heat treatment under an oxidizing atmosphere; and
a nanocrystallizing step of subjecting the magnetic core material that underwent the oxide film forming step to heat treatment under a non-oxidizing atmosphere to perform nanocrystallization of the nanocrystallizable Fe-based alloy, wherein
the highest temperature of the heat treatment at the oxide film forming step is a temperature of lower than a crystallization start temperature of the nanocrystallizable Fe-based alloy, and
the highest temperature of the heat treatment at the nanocrystallizing step is a temperature of equal to or higher than the crystallization start temperature of the nanocrystallizable Fe-based alloy.

[2] The method for producing the Fe-based nanocrystalline alloy magnetic core according to [1], comprising:
a magnetic field applying step of applying the magnetic core material that underwent the nanocrystallizing step with a magnetic field in a height direction of the magnetic core material while subjecting the magnetic core material to heat treatment, wherein
the highest temperature of the heat treatment at the magnetic field applying step is a temperature of lower than the crystallization start temperature of the nanocrystallizable Fe-based alloy.

[3] The method for producing the Fe-based nanocrystalline alloy magnetic core according to [1] or [2], wherein the nanocrystallizable Fe-based alloy has a composition represented by the following general formula (I):

FeₓSiₐB_{b}Cu_{c}Nb_{d} (I)

(in the general formula (I), a to d (at %) represent 3.0≤a≤12.0, 1.0≤b≤7.0, 1.0≤c≤5.0, and 1.0≤d≤9.0, respectively; and x (at %) is the balance other than Si, B, Cu, and Nb, and satisfies 73.0≤x≤92.0).

[4] A Fe-based nanocrystalline alloy magnetic core comprising a wound body of a ribbon, wherein
the ribbon has a first oxide film layer, a second oxide film layer, and a base material formed of a Fe-based nanocrystalline alloy comprising an amorphous phase and a crystal grain, in this order,
the Fe-based nanocrystalline alloy has a composition represented by the following general formula (I), and
a depth profile by an X-ray photoelectron spectroscopy of a sample X shown below satisfies the following (A) and (B),

FeₓSiₐB_{b}Cu_{c}Nbₐ (I)

(in the general formula (I), a to d (at %) represent 3.0≤a≤12.0, 1.0≤b≤7.0, 1.0≤c≤5.0, and 1.0≤d≤9.0, respectively; and x (at %) is the balance other than Si, B, Cu, and Nb, and satisfies 73.0≤x≤92.0)
(A) a peak of Cu₂ₚ appears within a depth range corresponding to the first oxide film layer; and
(B) within a depth range corresponding to the first oxide film layer, an intensity of the peak of Cu₂ₚ is stronger than an intensity of a peak of O_{1S} derived from SiO₂, wherein
(sample X) when a part between an inner circumferential surface and an outer circumferential surface of the Fe-based nanocrystalline alloy magnetic core is virtually divided into 3 regions of a first region, a second region, and a third region from the inner circumferential surface toward the outer circumferential surface, a ribbon situated in the second region is cut out, resulting in a sample; the first region, the second region, and the third region are regions that divide a radial length between the inner circumferential surface and the outer circumferential surface into 40/20/40; and an X-ray photoelectron spectroscopic analysis is performed on a surface of the sample that is opposed to the outer circumferential surface when the ribbon was wound to form the Fe-based nanocrystalline alloy magnetic core.

[5] The Fe-based nanocrystalline alloy magnetic core according to [4], the depth profile further satisfies the following (C) and (D),
(C) peaks of O_{1S} and Si₂ₚ derived from SiO₂ appear within a depth range corresponding to the second oxide film layer, and
(D) within a depth range corresponding to the second oxide film layer, an intensity of a peak of O_{1S} derived from SiO₂ is stronger than the intensity of a peak of Cu₂ₚ.

[6] The Fe-based nanocrystalline alloy magnetic core according to [4] or [5], the depth profile further satisfies the following (E),
(E) the intensity of a peak of Cu₂ₚ within a depth range corresponding to the first oxide film layer is stronger than the intensity of a peak of Cu₂ₚ within a depth range corresponding to the base material.

### Advantageous Effects of Invention

The present invention can provide a method for producing a Fe-based nanocrystalline alloy magnetic core having high magnetic permeability in the low frequency region.

Further, in accordance with a preferred aspect of the present invention, it is possible to provide a method for producing a Fe-based nanocrystalline alloy magnetic core having high magnetic permeability in both of the low frequency region and the high frequency region.

Still further, the present invention can provide a Fe-based nanocrystalline alloy magnetic core high magnetic permeability in the low frequency region by the producing method.

### BRIEF DESCRIPTION OF DRAWINGS

FIG. 1 is a graph showing the relative magnetic permeability of Fe-based nanocrystalline alloy magnetic cores obtained in Experimental Examples and Comparative Examples at a frequency of 10 kHz.

FIG. 2 is a graph showing the relative magnetic permeability of Fe-based nanocrystalline alloy magnetic cores obtained in Experimental Example and Comparative Examples at a frequency of 100 kHz.

FIG. 3 is a schematic view for illustrating a sample X for X-ray photoelectron spectroscopic analysis.

FIG. 4 is a TEM image of a cross section of a ribbon for forming each Fe-based nanocrystalline alloy magnetic core obtained in Example 2, Comparative Example 2, and Comparative Example 4 (drawing-substituting photograph).

FIG. 5 is the depth profile by X-ray photoelectron spectroscopic analysis of the Fe-based nanocrystalline alloy magnetic core obtained in Example 2.

FIG. 6 is the depth profile by X-ray photoelectron spectroscopic analysis of the Fe-based nanocrystalline alloy magnetic core obtained in Comparative Example 2.

FIG. 7 is the depth profile by X-ray photoelectron spectroscopic analysis of the Fe-based nanocrystalline alloy magnetic core obtained in Comparative Example 4.

### DESCRIPTION OF EMBODIMENTS

Below, embodiments of the present invention will be described in detail. The description of the claim components described below is one example (representative example) of the embodiment of the present invention. The present invention is not limited to the contents unless exceeding the gist thereof.

In the present description, when a numerical range of numerical values or physical property values is expressed using “to”, values before and after “to” are included in the numerical range.

### <1. Method for Producing Fe-Based Nanocrystalline Alloy Magnetic Core>

A method for producing a Fe-based nanocrystalline alloy magnetic core in accordance with a first embodiment of the present invention includes an oxide film forming step of subjecting a magnetic core material in which a ribbon of a nanocrystallizable Fe-based alloy is wound to heat treatment under an oxidizing atmosphere, and a nanocrystallizing step of subjecting the magnetic core material that underwent the oxide film forming step to heat treatment under a non-oxidizing atmosphere to perform nanocrystallization of the nanocrystallizable Fe-based alloy. Herein, the highest temperature of the heat treatment at the oxide film forming step is a temperature of lower than a crystallization start temperature of the nanocrystallizable Fe-based alloy, and the highest temperature of the heat treatment at the nanocrystallizing step is a temperature of equal to or higher than the crystallization start temperature of the nanocrystallizable Fe-based alloy.

The heat treatment temperature referred to in the present description is assumed to denote the set temperature of a heat treatment furnace for use in the heat treatment of the magnetic core material unless otherwise specified. The temperature of the magnetic core material itself is higher than the set temperature of the heat treatment furnace by about 5° C. to 10° C., and can be measured by mounting a thermocouple to the magnetic core material.

The Fe-based nanocrystalline alloy magnetic core obtainable with the producing method in accordance with the present embodiment exhibits high magnetic permeability in the low frequency region. In the present description, as the index for evaluation of the “magnetic permeability”, the “relative magnetic permeability” may be used.

In the present description, the magnetic permeability in the low frequency region is evaluated based on the magnetic permeability at a frequency of 10 KHz. Further, the magnetic permeability in the high frequency region is evaluated based on the magnetic permeability at a frequency of 100 KHz.

The relative magnetic permeability of the Fe-based nanocrystalline alloy magnetic core can be calculated by measuring the inductance of a sample prepared by wounding a coil around the Fe-based nanocrystalline alloy magnetic core, and based on the following equation (1).

$$μ r = μ / μ 0 \qquad ( 1 )$$

μr: relative magnetic permeability
μ0: vacuum magnetic permeability=4π×10⁻⁷ [H/m]
μ: magnetic permeability [H/m]=Ll/A/N²
L: inductance [H]
l: magnetic path length [m]
A: core effective cross sectional area [m²]
N: winding number

Although the producing method in accordance with the present embodiment is common to a conventional producing method (e.g., see Patent Document 2 or 3) in that the method is the method for producing a Fe-based nanocrystalline alloy magnetic core including an oxide film capable of suppressing the eddy current formed therein, the method can attain the improvement of the magnetic permeability in the low frequency region as distinct from the conventional producing method.

With the conventional producing method, by performing heat treatment under an oxidizing atmosphere, formation of an oxide film and nanocrystallization proceed at the same time. In contrast, the producing method in accordance with the present embodiment is the method in which at the oxide film forming step, an oxide film is formed without causing nanocrystallization, and at the nanocrystallizing step, nanocrystallization of a Fe-based alloy is performed without forming an oxide film enough to affect the magnetic permeability. The present inventors presume as follows. With the producing method in accordance with the present embodiment, the formation of an oxide film and nanocrystallization are performed in this manner separately in this order, and the formation of an oxide film and nanocrystallization are prevented from proceeding at the same time; as a result, the magnetic permeability in the low frequency region can be improved.

### <1-1. Oxide Film Forming Step>

The oxide film forming step is a step of subjecting a magnetic core material in which a ribbon of a nanocrystallizable Fe-based alloy (which may be hereinafter referred to simply as “Fe-based alloy”) is wound to heat treatment under an oxidizing atmosphere to form an oxide film on the surface of the Fe-based alloy ribbon. The highest temperature of the heat treatment at the oxide film forming step is a temperature of lower than the crystallization start temperature of a Fe-based alloy.

The Fe-based alloy configuring a Fe-based alloy ribbon is not particularly limited so long as it is a Fe-based alloy nanocrystallizable by heat treatment. Examples thereof may include a Fe—Si—B—Cu—Nb type alloy. As the specific composition of the Fe-Si-B-Cu-Nb type alloy, the composition represented by the following general formula (I) is preferably exemplified.

FeₓSiₐB_{b}Cu_{c}Nbₐ (I)

In the general formula (I), a to d (at %) represent 3.0≤a≤12.0, 1.0≤b ≤7.0, 1.0≤c≤5.0, and 1.0≤d≤9.0, respectively; and x (at %) is the balance other than Si, B, Cu, and Nb, and satisfies 73.0≤x≤92.0. The balance may include inevitable impurities.

The crystallization start temperature of the nanocrystallizable Fe-based alloy is usually 350° C. or higher and 520° C. or lower. In the case of the Fe—Si—B—Cu—Nb type alloy having the composition represented by the general formula (I), the crystallization start temperature thereof is usually 480° C. or higher and 520° C. or lower.

In the present description, the crystallization start temperature is defined as the temperature at which the exothermic reaction due to the start of nanocrystallization is detected when the measurement conditions of a differential scanning calorimeter (DSC) is set at a heating rate of 10° C./min.

The thickness and the width of the Fe-based alloy ribbon are not particularly limited so long as the ribbon can be form into a magnetic core in a practical shape by winding the ribbon. Specifically, the thickness of the ribbon is usually 8 μm or more and 25 μm or less, and the width of the ribbon is usually 5 mm or more and 25 mm or less.

As the magnetic core material, a commercially available magnetic core material may be used as it is. A magnetic core material produced by winding a commercially available Fe-based alloy ribbon may be used. Alternatively, a magnetic core material produced by rapidly solidifying a molten metal of a Fe-based alloy by a rapid quenching method for producing a Fe-based alloy ribbon, and winding the ribbon may be used.

With the rapid quenching method, the temperature of the molten metal upon quenching is desirably set at a temperature of higher than the melting point of the alloy by about 50° C. to 300° C. The rapid quenching method is not particularly limited, and a known method such as a single roll method, a twin roll method, an in-rotating-liquid spinning method, a gas atomizing method, or a water atomizing method can be adopted. Production of the Fe-based alloy ribbon with the rapid quenching method may be performed under an oxidizing atmosphere such as the atmosphere, may be performed under an inert gas atmosphere such as argon, helium, nitrogen, and the like, and may be performed under vacuum conditions.

The Fe-based alloy ribbon generally includes an amorphous phase. Although the Fe-based alloy ribbon preferably does not include a crystalline phase, it may partially include a crystalline phase so long as the effects of the present invention are not impaired.

As the oxidizing atmosphere, an oxygen-containing atmosphere such as an oxygen gas or the atmosphere can be adopted. The lower limit of the oxygen concentration of the oxygen-containing atmosphere is not particularly limited so long as an oxide film can be formed on the surface of the Fe-based alloy ribbon, and is usually 0.1 vol % or more, 0.2 vol % or more, 0.3 vol % or more, 1.0 vol % or more, 10.0 vol % or more, or 20.0 vol % or more. Whereas, the upper limit of the oxygen concentration of the oxygen-containing atmosphere is usually 100% or less, and may be 80.0 vol % or less, 60.0 vol % or less, or 40.0 vol % or less. Namely, examples of the preferable ranges of the oxygen concentration of the oxygen-containing atmosphere include the ranges of 0.1 vol % or more and 80.0 vol % or less, 0.2 vol % or more and 100% or less, 0.3 vol % or more and 60.0 vol % or less, 1.0 vol % or more and 60.0 vol % or less, 10.0 vol % or more and 40.0 vol % or less, and 20.0 vol % or more and 40.0 vol % or less. Moisture may be contained in the oxidizing atmosphere by adding a humidifying gas, a superheated steam, and the like to the oxidizing atmosphere. Further, in the oxide film forming step, the magnetic core material may be subjected boiling treatment before subjecting the magnetic core material to heat treatment under an oxidizing atmosphere.

The highest temperature of the heat treatment at the oxide film forming step depends on the kind of the oxidizing atmosphere, the heat treatment time, and the like, but it is usually 300° C. or more, and preferably 400° C. or more, and is usually lower than the crystallization start temperature of a Fe-based alloy, preferably equal to or lower than a temperature lower than the crystallization start temperature of the Fe-based alloy by 50° C., more preferably equal to or lower than a temperature lower than the crystallization start temperature of the Fe-based alloy by 60° C., and further preferably equal to or lower than a temperature lower than the crystallization start temperature of the Fe-based alloy by 70° C. Namely, examples of the preferable ranges of the highest temperature of the heat treatment include the ranges of 400° C. to a temperature lower than the crystallization start temperature of the Fe-based alloy by 50° C., 300° C. or more and lower than the crystallization start temperature of a Fe-based alloy, 400° C. to a temperature lower than the crystallization start temperature of the Fe-based alloy by 60° C., and 400° C. to a temperature lower than the crystallization start temperature of the Fe-based alloy by 70° C. By setting the highest temperature within the foregoing ranges, it is possible to suppress the simultaneous progress of the oxide film formation and the nanocrystallization of a Fe-based alloy while forming an oxide film on the surface of the Fe-based alloy ribbon configuring the magnetic core material. For this reason, it is possible to improve the magnetic permeability of the Fe-based nanocrystalline alloy magnetic core in the low frequency region.

The heating rate until the highest temperature is reached and the cooling rate after retention at the highest temperature are not particularly limited so long as the effects of the present invention are not impaired. The heating rate and the cooling rate that are generally adopted to the heat treatment in the technical field of the present invention is applicable.

The retention time at the highest temperature depends on the kind of the oxidizing atmosphere, the heat treatment temperature, and the like, but is usually 1hour or more, preferably 2 hours or more, and more preferably 3 hours or more, and usually 30 hours or less, preferably 20 hours or less, and more preferably 10hours or less. Namely, examples of the preferable ranges of the retention time at the highest temperature include the ranges of 1 hour or more and 20 hours or less, 2hours or more and 30 hours or less, and 3 hours or more and 10 hours or less. <1-2. Nanocrystallizing step>

The nanocrystallizing step is the step of subjecting the magnetic core material that underwent the oxide film forming step to heat treatment under a non-oxidizing atmosphere to perform nanocrystallization of the nanocrystallizable Fe-based alloy. The highest temperature of the heat treatment at the nanocrystallizing step is the temperature equal to or higher than the crystallization start temperature of the nanocrystallizable Fe-based alloy. A Fe-based nanocrystalline alloy which includes an amorphous phase and a crystal grain including a crystalline phase (bcc phase) is formed by the nanocrystallizing step.

In the present description, the non-oxidizing atmosphere means the atmosphere capable of suppressing the formation of an oxide film in such a degree as not to affect the magnetic permeability. Such non-oxidizing atmosphere is exemplified by an inert gas atmosphere such as argon, helium, nitrogen, and the like. The non-oxidizing atmosphere may contain a trace amount of oxygen. When the non-oxidizing atmosphere contains oxygen, the oxygen concentration thereof is usually less than 0.1 vol %, preferably 0.01 vol % or less, and more preferably 0.001vol % or less.

The lower limit of the highest temperature of the heat treatment at the nanocrystallizing step is not particularly limited so long as it is equal to or higher than the crystallization start temperature of a Fe-based alloy, and preferably equal to or higher than a temperature higher than the crystallization start temperature of the Fe-based alloy by 14° C. Further, the upper limit of the highest temperature of the heat treatment at the nanocrystallizing step is usually equal to or lower than a temperature higher than the crystallization start temperature of a Fe-based alloy by 59° C., and preferably equal to or lower than a temperature higher than the crystallization start temperature of a Fe-based alloy by 44° C. More specifically, when the crystallization start temperature of a Fe-based alloy is about 516° C., the heat treatment temperature at the nanocrystallizing step is usually 516° C. or higher, and is preferably 530° C. or higher, and is usually 575° C. or less, and is preferably 560° C. or less. Namely, examples of the preferable ranges of the highest temperature of the heat treatment include the ranges of a temperature higher than the crystallization start temperature of the Fe-based alloy by 14° C. to a temperature higher than the crystallization start temperature of the Fe-based alloy by 59° C., and a temperature higher than the crystallization start temperature of the Fe-based alloy by 14° C. to a temperature higher than the crystallization start temperature of the Fe-based alloy by 44° C. More specifically, examples of the preferable ranges of the highest temperature of the heat treatment include the ranges of 516° C. or higher and 560° C. or lower, and 530° C. or higher and 575° C. or lower.

The heating rate until the highest temperature is reached and the cooling rate after retention at the highest temperature are not particularly limited so long as the effects of the present invention are not impaired. The heating rate and the cooling rate that are generally adopted to the heat treatment in the technical field of the present invention is applicable.

The retention time at the highest temperature depends on the composition of the Fe-based alloy, the size of the magnetic core, and the like, but it is usually 30minutes or more, preferably 50 minutes or more, and more preferably 90 minutes or more, and usually 10 hours or less, and preferably 2 hours or less from the viewpoint of uniformly heating the whole alloy and the viewpoint of the productivity. Namely, examples of the preferable ranges of the retention time at the highest temperature include the ranges of 30 minutes or more and 2 hours or less, 50 minutes or more and 10 hours or less, and 90 minutes or more and 10 hours or less.

The nanocrystallizing step may further include, in the process of raising the heat treatment temperature up to the highest temperature, a thermally insulating step of temporarily stopping a temperature rise when the heat treatment temperature reached to a temperature of lower than the highest temperature and retaining the heat treatment temperature.

For nanocrystallization of the Fe-based alloy, overshoot in which the temperature of the magnetic core material becomes higher than the set temperature of the heat treatment furnace due to the heat generated from the magnetic core material during precipitation of the crystalline phase may be caused. In such a case, it is possible to suppress the overshoot by the thermally insulating step. The overshoot causes a variation in magnetic permeability of the Fe-based nanocrystalline alloy magnetic core. Therefore, suppression of the overshoot uniformizes the temperature of the inside of the magnetic core material. As a result, it is possible to suppress a variation in magnetic permeability of the Fe-based nanocrystalline alloy magnetic core. Here, the suppression of the overshoot means that when the thermally insulating step is performed, the difference between the set temperature of the heat treatment furnace for nanocrystallization and the actual temperature of the magnetic core material becomes smaller than that when the thermally insulating step was not performed.

By performing the thermally insulating step, the overshoot in nanocrystallization is suppressed, and further, the variation in magnetic permeability of the Fe-based nanocrystalline alloy magnetic core is suppressed. The reason for this is presumed by the present inventors as follows.

When overshoot is caused in nanocrystallization of the Fe-based alloy, a temperature equal to or higher than the set temperature of the heat treatment furnace is applied to the magnetic core. Accordingly, the precipitation of the crystalline phase may excessively proceed, which may cause a variation in magnetic permeability of the Fe-based nanocrystalline alloy magnetic core. Herein, it is presumed as follows. When the thermally insulating step is performed before the nanocrystallization, the heat energy amount to be applied to the magnetic core material in which the Fe-based alloy ribbon is wound is suppressed. For this reason, the precipitation speed of the crystalline phase becomes slow, so that heat generated caused by the precipitation of the crystalline phase is suppressed. As a result, the overshoot is suppressed, and further, the variation in magnetic permeability of the Fe-based nanocrystalline alloy magnetic core is suppressed.

The heat treatment temperature at the thermally insulating step is not particularly limited so long as it is a temperature of lower than the highest temperature of the nanocrystallizing step, and is usually equal to or higher than a temperature lower than the crystallization start temperature of the Fe-based alloy by 65° C., and preferably equal to or higher than a temperature lower than the crystallization start temperature of the Fe-based alloy by 60° C., and further, is usually equal to or lower than a temperature lower than the crystallization start temperature of the Fe-based alloy by 45° C., and preferably equal to or lower than a temperature lower than the crystallization start temperature of the Fe-based alloy by 40° C. Namely, examples of the preferable ranges of the heat treatment temperature include the ranges of a temperature lower than the crystallization start temperature of the Fe-based alloy by 65° C. to a temperature lower than the crystallization start temperature of the Fe-based alloy by 40° C. or less, and a temperature lower than the crystallization start temperature of the Fe-based alloy by 60° C. to a temperature lower than the crystallization start temperature of the Fe-based alloy by 45° C. or lower.

The heat treatment time at the thermally insulating step depends on the heat treatment temperature at the thermally insulating step, the size of the magnetic core material, and the like, but it is usually 30 minutes or more, preferably 60 minutes or more, and more preferably 100 minutes or more, and further, is usually 5 hours or less, preferably 4 hours or less, and more preferably 3 hours or less from the viewpoint of uniformalizing the temperature of the inside of the heat treatment furnace. Namely, examples of the preferable ranges of the heat treatment time include the ranges of 30 minutes or more and 4 hours or less, 60 minutes or more and 5 hours or less, and 100 minutes or more and 3 hours or less. After an elapse of the heat treatment time, namely, after completion of the thermally insulating step, the temperature is increased up to the highest temperature of the heat treatment at the nanocrystallizing step, so that the nanocrystallization of a Fe-based alloy is allowed to sufficiently proceed.

### <1-3. Magnetic Field Applying Step>

The producing method in accordance with the present embodiment may further include a magnetic field applying step of applying the magnetic core material that underwent the nanocrystallizing step with a magnetic field in a height direction of the magnetic core material while subjecting the magnetic core material to heat treatment. From the viewpoint of improving the magnetic permeability of the Fe-based nanocrystalline alloy magnetic core in the high frequency region, the magnetic field applying step is preferably performed.

The highest temperature of the heat treatment at the magnetic field applying step is not particularly limited, and is usually 300° C. or more, and preferably 400° C. or more, and further, is usually less than the crystallization start temperature of a Fe-based alloy, preferably equal to or lower than a temperature lower than the crystallization start temperature of the Fe-based alloy by 50° C., and more preferably equal to or lower than a temperature lower than the crystallization start temperature of the Fe-based alloy by 60° C. Namely, examples of the preferable ranges of the highest temperature of the heat treatment include the ranges of 400° C. or more and less than the crystallization start temperature of a Fe-based alloy, 300° C. to a temperature lower than the crystallization start temperature of the Fe-based alloy by 50° C., and 400° C. to a temperature lower than the crystallization start temperature of the Fe-based alloy by 60° C.

The heating rate until the highest temperature is reached and the cooling rate after retention at the highest temperature are not particularly limited so long as the effects of the present invention are not impaired. The heating rate and the cooling rate that are generally adopted to the heat treatment in the technical field of the present invention is applicable.

The retention time at the highest temperature depends on the highest temperature, the size of the magnetic core material, and the like, but it is usually 20 minutes or more, and preferably 30 minutes or more, and further, is usually 5 hours or less, preferably 2 hours or less, and more preferably 1 hour or less from the viewpoint of uniformalizing the temperature of the inside of the heat treatment furnace. Namely, examples of the preferable ranges of the retention time at the highest temperature include the ranges of 20 minutes or more and 2 hours or less, 30 minutes or more and 5 hours or less, and 30 minutes or more and 1 hour or less.

At the magnetic field applying step, a magnetic field in the height direction of the magnetic core material, namely in the width direction of the Fe-based alloy ribbon configuring the magnetic core material is applied to the magnetic core material. The intensity of the magnetic field to be applied to the magnetic core material is not particularly limited so long as it is high enough to magnetically saturate the magnetic core, and is usually 50 mT or more, preferably 80 mT or more, and more preferably 100 mT or more, and further is usually 150 mT or less. Namely, examples of the preferable ranges of the magnetic field intensity include the ranges of 50 mT or more and 150 mT or less, 80 mT or more and 150 mT or less, and 100 mT or more and 150 mT or less.

The magnetic field applying step may be performed under an oxidizing atmosphere such as the atmosphere, may be performed under an inert gas atmosphere such as argon, helium, nitrogen, and the like, and may be performed under vacuum conditions. The magnetic field applying step is preferably performed under an inert gas atmosphere.

In the foregoing description, each heat treatment at the oxide film forming step, the nanocrystallizing step, and the magnetic field applying step was referred to as the step including a temperature rise, retention at the highest temperature, and a temperature drop. However, a temperature rise or a temperature drop is not necessarily required. For example, the nanocrystallizing step may be performed in the following manner. After the heat treatment at the oxide film forming step, the atmosphere of the heat treatment furnace is replaced from the oxidizing atmosphere to a non-oxidizing atmosphere, and further the temperature is increased. However, in consideration of the necessity of replacement of the atmosphere in the heat treatment furnace, the necessity of magnetic field application, producing facilities, and the like, all the heat treatments at respective steps preferably include a series of operations of a temperature rise, retention at the highest temperature, and a temperature drop.

### <2. Fe-Based Nanocrystalline Alloy Magnetic Core>

A Fe-based nanocrystalline alloy magnetic core in accordance with a second embodiment of the present invention is a magnetic core including a wound body of a ribbon. The ribbon has a first oxide film layer, a second oxide film layer, and a base material formed of a Fe-based nanocrystalline alloy containing an amorphous phase and a crystal grain, in this order. The Fe-based nanocrystalline alloy has a composition represented by the following general formula (I). When a specific sample sampled from the Fe-based nanocrystalline alloy magnetic core in accordance with the present embodiment is subjected to X-ray photoelectron spectroscopic (XPS) analysis, a characteristic depth profile described later is obtained.

FeₓSiₐB_{b}Cu_{c}Nbₐ (I)

The general formula (I) is the same as the general formula (I) described in the <1-1. Oxide film forming step>. Therefore, each definition and preferable aspect of a to d (at %) and x (at %) are as described in the <1-1. Oxide film forming step>.

The Fe-based nanocrystalline alloy magnetic core in accordance with the present embodiment is the magnetic core obtainable using a Fe—Si—B—Cu—Nb type alloy having the composition represented by the general formula (I) as a nanocrystallizable Fe-based alloy with the producing method in accordance with the first embodiment of the present invention, and exhibits high magnetic permeability in the low frequency region. For producing the Fe-based nanocrystalline alloy magnetic core in accordance with the present embodiment, the magnetic field applying step described in the <1-3. Magnetic field applying step> is not required to be performed. This is because the magnetic field application does not affect, or slightly affects the structure and the composition of the oxide film. However, the Fe-based nanocrystalline alloy magnetic core is preferably a product that is produced by the producing method including the magnetic field applying step because the Fe-based nanocrystalline alloy magnetic core produced through the magnetic field applying step exhibits high magnetic permeability in both of the low frequency region and the high frequency region.

### <2-1. First Oxide Film Layer, Second Oxide Film Layer, and Base Material>

A Fe-based nanocrystalline alloy magnetic core in accordance with the present embodiment is produced by the producing method in accordance with the first embodiment of the present invention. For this reason, the ribbon configuring the magnetic core has the first oxide film layer, the second oxide film layer, and the base material formed of the Fe-based nanocrystalline alloy including an amorphous phase and the crystal grain, in this order. The first oxide film layer is the outermost surface layer of the ribbon.

The first oxide film layer and the second oxide film layer are formed by the oxide film forming step in the producing method. Further, the base material is formed by nanocrystallization of the nanocrystallizable Fe—Si—B—Cu—Nb type alloy having the composition represented by the general formula (I) at the nanocrystallizing step in the producing method. The base material may include other components than the Fe-based nanocrystalline alloy, for example, the components mixed therein at the step of forming a ribbon, the oxide film forming step, or the like.

In the present embodiment, the first oxide film layer and the second oxide film layer may be formed on at least one surface of the ribbon, and are generally formed on both the surfaces of the ribbon. Further, the first oxide film layer and the second oxide film layer may be formed on at least a part of the surface of the ribbon, and are generally formed over the entire ribbon surface.

The total thickness of the first oxide film layer and the second oxide film layer is not particularly limited, and is usually 5.0 nm or more, preferably 8.0 nm or more, more preferably 10 nm or more, and further preferably 12 nm or more, and further, is usually 25 nm or less, and preferably 20 nm or less because an oxide film having a thickness of about 4 nm is formed by natural oxidation. Namely, examples of the preferable ranges of the total thickness of the first oxide film layer and the second oxide film layer include the ranges of 5.0 nm or more and 20 nm or less, 8.0 nm or more and 20 nm or less, 10 nm or more and 25 nm or less, and 12 nm or more and 25 nm or less.

The presence or absence of the first oxide film layer and the second oxide film layer can be confirmed by transmission electron microscope (TEM) observation of the ribbon cross section. Further, the thicknesses of the first oxide film layer and the second oxide film layer can be measured from the TEM image. Photographing by a TEM is performed so as to obtain a TEM image in the vicinity of the ribbon surface targeted for XPS analysis for comparing the TEM observation results and the XPS analysis results of the first oxide film layer and the second oxide film layer. For TEM observation, a protective layer may be formed on the first oxide film layer in order to improve the visibility of the first oxide film layer and the second oxide film layer in the TEM image. The protective layer can be formed by a known method, for example, a deposition system. As the materials for the protective layer, carbon, platinum, tungsten, and the like can be used. Further, the sample for observing the ribbon cross section can be obtained by, for example, cutting the ribbon by a focused ion beam method (FIB method). An example of the measurement conditions for TEM is described below.

### (TEM Measurement Conditions)

Device: JEM-2100 (provided by JEOL Ltd.)
Acceleration voltage: 200 kV
Magnification: 100,000 times or 200,000 times

### <2-2. Depth Profile by XPS Analysis>

When the Fe-based nanocrystalline alloy magnetic core in accordance with the present embodiment is subjected to XPS analysis of the surface structure of a ribbon including a first oxide film layer, a second oxide film layer, and a base material, the characteristic depth profile satisfying the following (A) and (B) is obtained.
(A) A peak of Cu₂ₚ appears within a depth range corresponding to the first oxide film layer.
(B) Within a depth range corresponding to the first oxide film layer, an intensity of the peak of Cu₂ₚ is stronger than an intensity of a peak of O_{1S} derived from SiO₂.

As shown in Example described later, with the depth profile of a conventional Fe-based nanocrystalline alloy magnetic core, the peak (maximum value) of Cu₂ₚ is observed not within the depth rage corresponding to the first oxide film layer (i.e., the outermost surface layer) but within the depth range corresponding to that between the second oxide film layer and the base material. For this reason, the conventional Fe-based nanocrystalline alloy magnetic core does not satisfy (A) and (B). Therefore, the depth profile satisfying (A) and (B) is characteristic of the Fe-based nanocrystalline alloy magnetic core in accordance with the present embodiment.

Further, the Fe-based nanocrystalline alloy magnetic core in accordance with the present embodiment preferably further satisfies the following (C) and (D) with the depth profile by XPS analysis.
(C) Peaks of O_{1S} and Si₂ₚ derived from SiO₂ appear within a depth range corresponding to the second oxide film layer.
(D) Within a depth range corresponding to the second oxide film layer, an intensity of a peak of O_{1S} derived from SiO₂ is stronger than the intensity of a peak of Cu₂ₚ.

As shown in Example described later, with the depth profile when an oxide film is formed on the ribbon surface by natural oxidation, the peaks of O_{1S} and Si₂ₚ derived from SiO₂ are observed within the depth range corresponding to the first oxide film layer. Therefore, the depth profile satisfying (C) in addition to (A) and (B) is also characteristic of the Fe-based nanocrystalline alloy magnetic core in accordance with the present embodiment.

Further, the Fe-based nanocrystalline alloy magnetic core in accordance with the present embodiment preferably further satisfies the following (E) with the depth profile by XPS analysis.
(E) The intensity of a peak of Cu₂ₚ within a depth range corresponding to the first oxide film layer is stronger than the intensity of a peak of Cu₂ₚ within a depth range corresponding to the base material.

As shown in Example described later, with the depth profile of the conventional Fe-based nanocrystalline alloy magnetic core, within the depth range corresponding to the first oxide film layer, the peak (maximum value) of Cu₂ₚ does not appear, and a signal of Cu₂ₚ with a weak intensity is observed. Additionally, within the depth range corresponding to the base material, a signal of Cup with a stronger intensity than that within the depth range corresponding to the first oxide film layer is observed. For this reason, the depth profile satisfying (E) is also characteristic of the Fe-based nanocrystalline alloy magnetic core in accordance with the present embodiment.

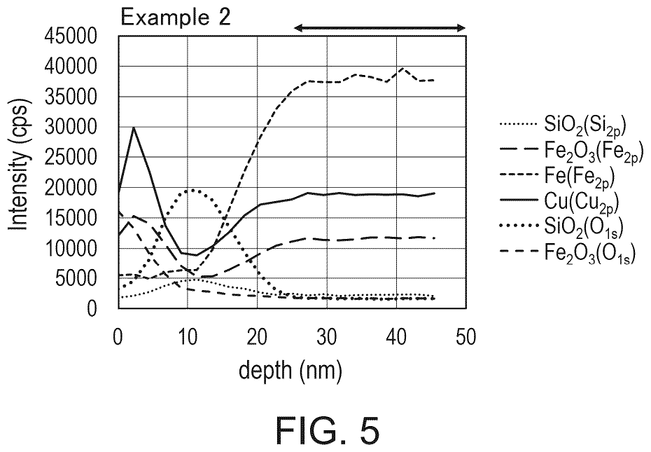

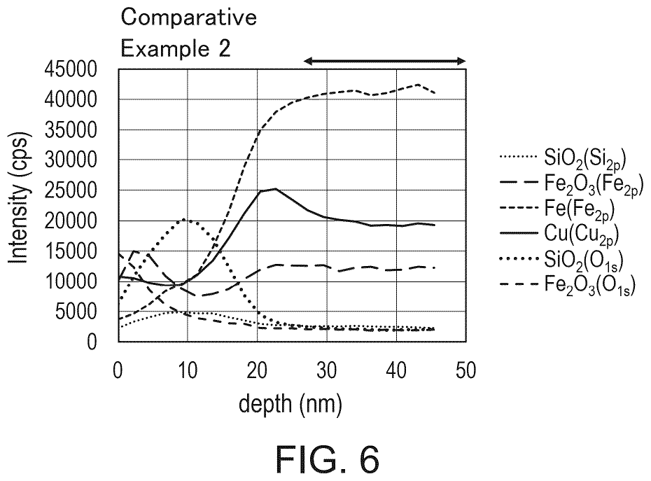

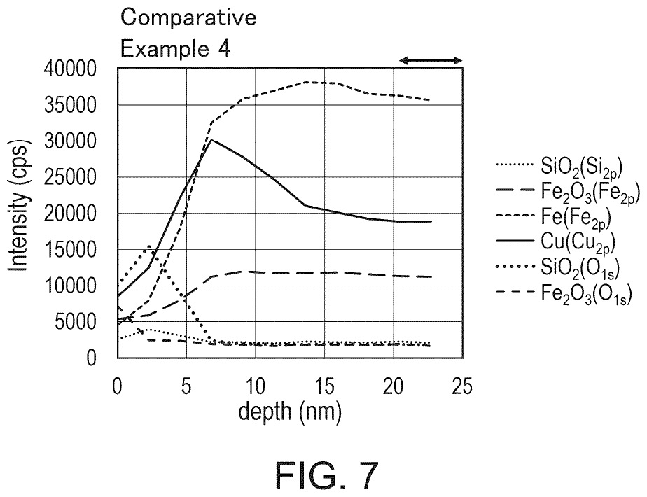

In the present description, the depth ranges corresponding to the first oxide film layer and the second oxide film layer are the ranges based on the thicknesses of the first oxide film layer and the second oxide film layer measured from the TEM images, respectively. Further, as the intensity of the peak of Cu₂ₚ within the depth range corresponding to the base material, the intensity of the peak of Cu₂ₚ at a depth in which the effect of the oxide film is not observed is adopted. More specifically, such a depth range with a small variation in signal intensity that the ratio of the minimum intensity of the peak of Cu₂ₚ to the maximum intensity of the peak of Cu₂ₚ within the depth range of 5 nm is usually 0.80 or more, preferably 0.85 or more, and more preferably 0.90 or more is selected, and the intensity of the peak of Cu₂ₚ within this depth range is assumed to be the intensity of the peak of Cu₂ₚ within the depth range corresponding to the base material. Examples of such a depth range with a small variation in signal intensity include a depth range of 15 nm or more as described in Example 2 below, a depth range of 28 nm or more as described in Comparative Example 2 below, and a depth range of 21 nm or more as described in Comparative Example 4 below (the ranges indicated with arrows in FIGS. 5 to 7).

In the present embodiment, a specific sample to be subjected to XPS analysis is the following sample X.

(sample X) when a part between an inner circumferential surface and an outer circumferential surface of the Fe-based nanocrystalline alloy magnetic core is virtually divided into 3 regions of a first region, a second region, and a third region from the inner circumferential surface toward the outer circumferential surface, a ribbon situated in the second region is cut out, resulting in a sample; the first region, the second region, and the third region are regions that divide a radial length between the inner circumferential surface and the outer circumferential surface into 40/20/40; and an X-ray photoelectron spectroscopic analysis is performed on a surface of the sample that is opposed to the outer circumferential surface when the ribbon was wound to form the Fe-based nanocrystalline alloy magnetic core.

The reason why the ribbon situated in the second region is as follows.

In the magnetic core including a wound ribbon, the magnetic permeability is affected by the oxide film layer formed on the surface of the ribbon located in the vicinity of the intermediate part between the inner circumferential surface and the outer circumferential surface in the radial direction of the magnetic core, or the ribbon located a little closer to the inner circumferential surface side than to the vicinity of the intermediate part. Further, the oxide film layer formed on the surface of the ribbon situated on the outer circumferential surface side in the radial direction of the magnetic core may be affected by the ambient environment in the producing step of the magnetic core. For this reason, a specific oxide film is stably formed regardless of the ambient environment on the surface of the ribbon located in the vicinity of the radial intermediate part of the magnetic core, or the ribbon located a little closer to the inner circumferential surface side than to vicinity of the intermediate part. Therefore, for evaluating the configuration of the oxide film contributing to the improvement of the magnetic permeability, it is necessary to analyze the oxide film layer formed on the surface of the ribbon located in the vicinity of the intermediate part between the inner circumferential surface and the outer circumferential surface, or the ribbon located a little closer to the inner circumferential surface side than to the vicinity of the intermediate part.

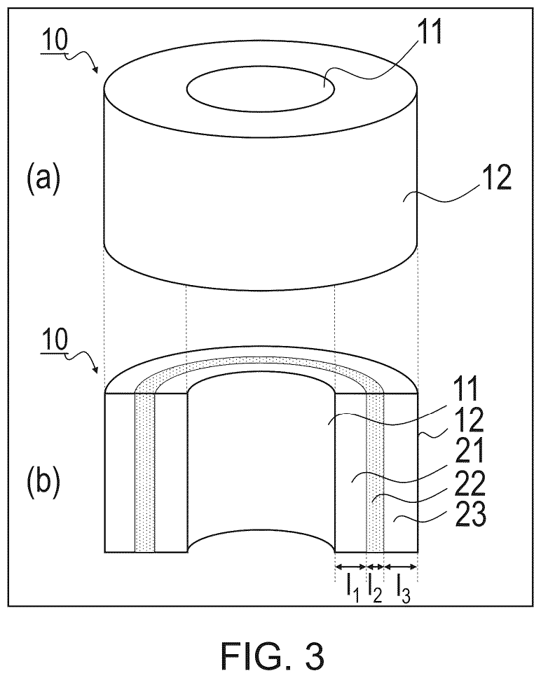

The sample X for XPS analysis will be described in more details with reference to FIG. 3. FIG. 3(a) is a perspective view of a Fe-based nanocrystalline alloy magnetic core, and FIG. 3(b) is a cross sectional perspective view of the Fe-based nanocrystalline alloy magnetic core. As shown in FIG. 3(a), a Fe-based nanocrystalline alloy magnetic core 10 in accordance with the present embodiment is the magnetic core including a ribbon which is toroidally wound. The ribbon is stacked between the inner circumferential surface 11 and the outer circumferential surface 12 of the Fe-based nanocrystalline alloy magnetic core 10 by winding it into a toroidal shape. Herein, as shown in FIG. 3(b), the parts obtained by virtually dividing the radial length of the part between the inner circumferential surface 11 and the outer circumferential surface 12 of the Fe-based nanocrystalline alloy magnetic core 10 into 3 regions are referred to as a first region 21, a second region 22, and a third region 23 sequentially from the inner circumferential surface 11 toward the outer circumferential surface 12. The first region 21, the second region 22, and the third region 23 are regions dividing the radial length of the part between the inner circumferential surface 11 and the outer circumferential surface 12 into l₁/l₂/l₃. The l₁/l₂/l₃ may be usually 40/20/40, may be 40/15/45, and may be 45/10/45. The XPS analysis is performed in the following manner. The ribbon in the second region 22, namely, the central portion between the inner circumferential surface 11 and the outer circumferential surface 12 of the Fe-based nanocrystalline alloy magnetic core 10 is cut out, and the surface, of both the surfaces of the ribbon, opposed to the outer circumferential surface 12 when the ribbon has been wound is used as the analysis surface. In the XPS analysis, the photoelectron intensity is measured for each depth from the ribbon surface while sputtering the analysis surface. An example of the conditions for the XPS analysis is described below.

(XPS analysis conditions)
Device: PHI 5000 Versa Probe (provided by ULVAC-PHI, Inc.)
Ultimate pressure: 6.7×10⁻⁸ Pa or less
Excitation source: monochrome Al-Kα X ray
Output: 25 W
Detected area: 100 μmφ
Angle of incidence: 45°
Take-off angle: 45°
   (Sputtering conditions)
Ion species: argon
Acceleration voltage: 1 kV
Sweep area: 2 mm×2 mm
Sputtering rate: 2.27 nm/min

For the XPS analysis, a chart with the depth in terms of SiO₂ (nm) calculated using the sputter etching rate of the SiO₂ standard sample from the sputtering time on the horizontal axis, and the photoelectron intensity (cps) on the vertical axis is formed to acquire the depth profile. Thus, whether the (A) to (E) are satisfied or not is determined.

### <3. Use of Fe-Based Nanocrystalline Alloy Magnetic Core>

The Fe-based nanocrystalline alloy magnetic core produced with the producing method in accordance with the first embodiment of the present invention and the Fe-based nanocrystalline alloy magnetic core in accordance with the second embodiment of the present invention can be preferably used as the magnetic core for a reactor, a common mode choke coil, a transformer, a communicating pulse transformer, a motor, a generator, or the like.

### EXAMPLES

The present invention will be further described specifically by way of

Examples below. The present invention is not limited to the description of the following Examples unless it exceeds the gist thereof.

### Example 1

A Fe-based alloy ribbon which is made of a Fe—Si—B—Cu—Nb type alloy having the composition represented by the general formula (I), and which has a width of 12.5 mm and a thickness of 14 μm was wound to give a Fe-based alloy magnetic core material with an outer diameter of 25 mm, an inner diameter of 15 mm, and a height of 12.5 mm. Here, the crystallization start temperature of the Fe-based alloy configuring the Fe-based alloy ribbon was determined by measurement with a differential scanning calorimeter (DSC), and was found to be 516° C.

### (Oxide Film Forming Step)

The Fe-based alloy magnetic core material was placed in a heat treatment furnace, and was heated at the highest temperature of 440° C. under an oxidizing atmosphere with an oxygen concentration of 0.4 vol % for 180 minutes to form an oxide film.

### (Nanocrystallizing Step)

The Fe-based alloy magnetic core material that underwent the oxide film forming step was placed in a heat treatment furnace, and was heated under a nitrogen atmosphere (oxygen concentration of 0 vol %) at 470° C. for 120 minutes, and was further heated at 550° C. for 100 minutes to perform the nanocrystallization of the Fe-based alloy. The magnetic core material that underwent nanocrystallization was cooled room temperature (20° C.), resulting in a Fe-based nanocrystalline alloy magnetic core of Example 1.

### Example 2

### (Magnetic Field Applying Step)

The Fe-based nanocrystalline alloy magnetic core obtained in Example 1 was placed in a heat treatment furnace. While performing heat treatment under a nitrogen atmosphere (oxygen concentration of 0 vol %), the magnetic core was applied with a magnetic field having a magnetic field intensity of 100 mT in the height direction of the magnetic core. The magnetic core after application with a magnetic field was cooled to room temperature (20° C.), resulting in a Fe-based nanocrystalline alloy magnetic core. Here, the heat treatment was performed under such conditions that the retention time at the highest temperature of 450° C. was 30 minutes.

### Comparative Example 1

A Fe-based nanocrystalline alloy magnetic core was obtained in the same manner as in Example 1, except that the oxide film forming step was not performed, and that the nanocrystallizing step was performed under an oxidizing atmosphere with an oxygen concentration of 0.4 vol %.

### Comparative Example 2

A Fe-based nanocrystalline alloy magnetic core was obtained in the same manner as in Example 2, except that the oxide film forming step was not performed, and that the nanocrystallizing step was performed under an oxidizing atmosphere with an oxygen concentration of 0.4 vol %.

### Comparative Example 3

A Fe-based nanocrystalline alloy magnetic core was obtained in the same manner as in Example 1, except that the oxide film forming step was not performed.

### Comparative Example 4

A Fe-based nanocrystalline alloy magnetic core was obtained in the same manner as in Example 2, except that the oxide film forming step was not performed.

### [Evaluation of Relative Magnetic Permeability]

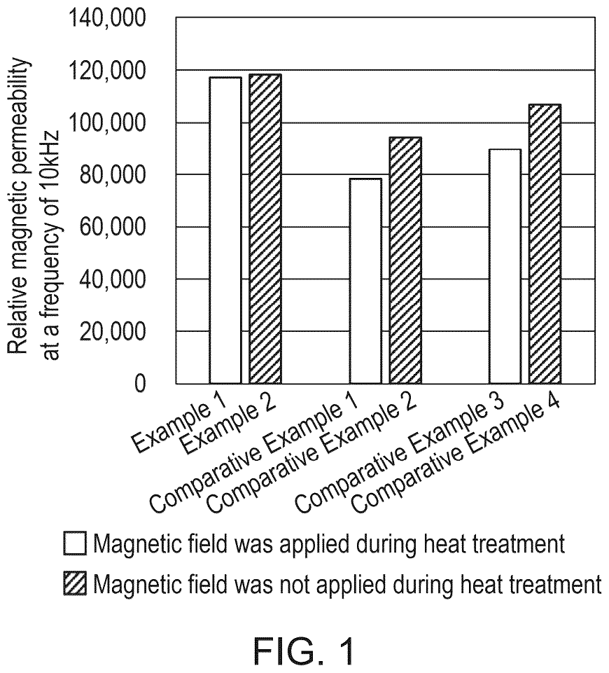

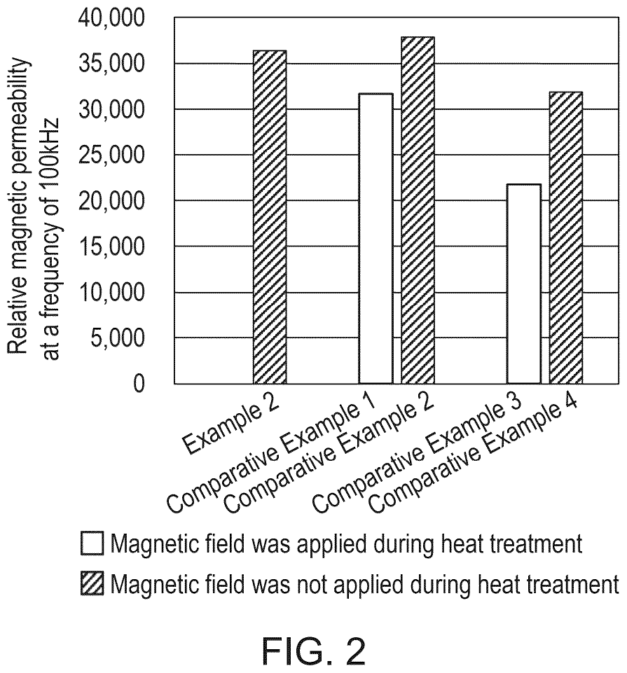

Each Fe-based nanocrystalline alloy magnetic core obtained in Example and Comparative Example was mounted in a resin case to give a hollow core. A coated copper wire with a wire diameter of 0.5 mm was caused to penetrate through the hollow portion of the produced core to give a 1-turn core. The inductance of the obtained core was measured by an impedance analyzer (4294A provided by Agilent Technologies Co.,) at frequencies of 10 kHz and 100 kHz, and the relative magnetic permeability of the Fe-based nanocrystalline magnetic core was calculated based on the following equation (1). Here, the magnetic path length l was set at 6.3×10⁻² m, and the effective cross sectional area A was set at 4.8×10⁻⁵ m², and the winding number N was set at 1. The results are shown in Table 1, and FIGS. 1 and 2.

$$μ r = μ / μ 0 \qquad ( 1 )$$

μr: relative magnetic permeability
μ0: vacuum magnetic permeability=4π×10⁻⁷ [H/m]
μ: magnetic permeability [H/m]=Ll/A/N²
L: inductance [H]
l: magnetic path length [m]=6.3×10⁻² [m]
A: core effective cross sectional area [m²]=4.8×10⁻⁵ [m²]
N: winding number=1

TABLE 1

| | | oxygen | | relative | |
|---|---|---|---|---|---|
| | oxide | concentra- | magnetic | magnetic | |
| | film | tion in nano- | field | permeability | |
| | forming | crystallizing | applying | 10 | 100 |
| | step | step (vol %) | step | kHz | kHz |
| Example 1 | performed | 0 | not | 117,225 | — |
| | | | performed | | |
| Example 2 | performed | 0 | performed | 118,139 | 36,355 |
| Comparative | not | 0.4 | not | 78,406 | 31,717 |
| Example 1 | performed | | performed | | |
| Comparative | not | 0.4 | performed | 94,322 | 37,847 |
| Example 2 | performed | | | | |
| Comparative | not | 0 | not | 89,595 | 21,747 |
| Example 3 | performed | | performed | | |
| Comparative | not | 0 | performed | 106,794 | 31,891 |
| Example 4 | performed | | | | |

Table 1 and FIG. 1 indicate as follows: the Fe-based nanocrystalline alloy magnetic core (Comparative Example 1) obtained by performing formation of an oxide film with nanocrystallization had lower in relative magnetic permeability at a frequency of 10 kHz than the Fe-based nanocrystalline alloy magnetic core (Comparative Example 3) obtained by performing only nanocrystallization without forming an oxide film; and the magnetic permeability of the Fe-based nanocrystalline alloy magnetic core in the low frequency region was reduced due to the formation of the oxide film.

On the other hand, a Fe-based nanocrystalline alloy magnetic core (Example 1) obtained by formation of an oxide film under the conditions not causing nanocrystallization followed by nanocrystallization under a non-oxidizing atmosphere not causing the formation of an oxide film exhibited remarkably improved relative magnetic permeability at a frequency of 10 kHz, regardless of having an oxide film as with the Fe-based nanocrystalline alloy magnetic core obtained in Comparative Example 1, and also exhibited higher relative magnetic permeability at a frequency of 10 kHz than the Fe-based nanocrystalline alloy magnetic core obtained in Comparative Example 3

The results show that when oxide film formation and nanocrystallization were performed separately in this order, the magnetic permeability of the Fe-based nanocrystalline alloy magnetic core in the low frequency region is improved contrary to the technical common sense that the formation of the oxide film causes reduction in the magnetic permeability of the nanocrystalline alloy magnetic core in the low frequency region.

Further, Table 1 and FIG. 1 indicate that the magnetic permeability of the Fe-based nanocrystalline alloy magnetic core in the low frequency region is improved, also by performing magnetic field application.

From Table 1 and FIG. 2, the relative magnetic permeability at a frequency of 100 kHz of the Fe-based nanocrystalline alloy magnetic core (Example 2) obtained by sequentially performing oxide film formation, nanocrystallization, and magnetic field application was a value as high as that of the Fe-based nanocrystalline alloy magnetic core (Comparative Example 2) obtained by applying the magnetic core material produced by simultaneously performing formation of an oxide film and nanocrystallization with a magnetic field.

The results show that a Fe-based nanocrystalline alloy magnetic core also having high magnetic permeability in the high frequency region can be produced by performing the magnetic field applying step.

### [TEM Observation]

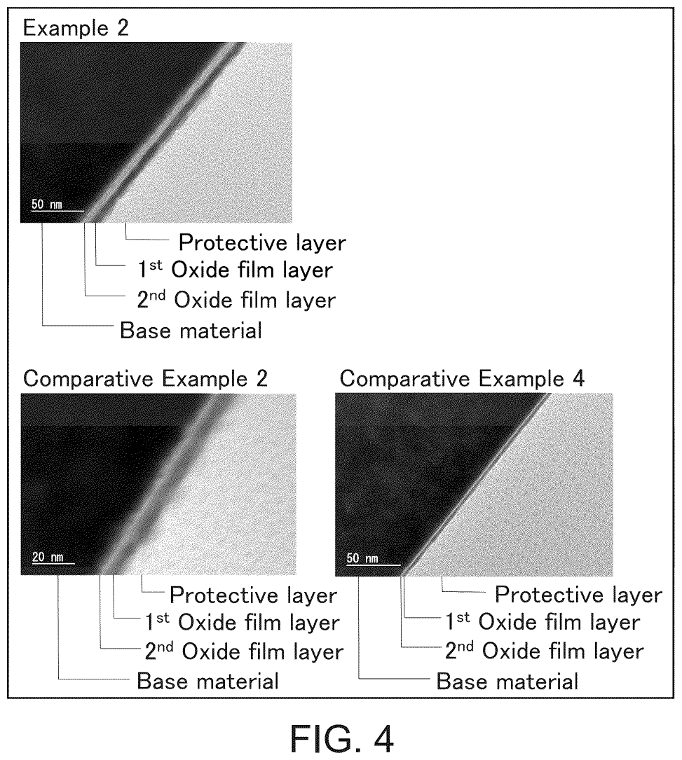

From each Fe-based nanocrystalline alloy magnetic core obtained in Example 2, Comparative Example 2, and Comparative Example 4, a ribbon under the same conditions as those for the sample X for XPS analysis was cut out (where, l₁/l₂/l₃=45/10/45). Then, a protective layer was formed with the deposition method on the surface under the same conditions as those for the analysis surface for XPS analysis of both the surfaces of the ribbon. The ribbon covered with the protective layer was cut perpendicular to the surface to give a sample for TEM observation. For the resulting sample for TEM observation, measurement of the TEM was performed under the following measurement conditions. The resulting TEM image is shown in FIG. 4.

(TEM measurement conditions)
Device: JEM-2100 (provided by JEOL Ltd.)
Acceleration voltage: 200 kV
Magnification: 100,000 times (Example 2, Comparative Example 4) or 200,000 times (Comparative Example 2)

FIG. 4 indicates that all of the Fe-based nanocrystalline alloy magnetic cores obtained in Example 2, Comparative Example 2, and Comparative Example 4 each have two oxide film layers on the ribbon surface. The thickness of each oxide film layer measured from FIG. 4 is shown in Table 2.

TABLE 2

| | thickness of first | thickness of second |
|---|---|---|
| | oxide film layer (nm) | oxide film layer (nm) |
| Example 2 | 7.70 | 6.20 |
| Comparative | 7.29 | 2.37 |
| Example 2 | | |
| Comparative | 3.52 | 0.89 |
| Example 4 | | |

FIG. 4 and Table 2 indicate that in Example 2 in which prior to nanocrystallization, an oxide film was formed, and then, nanocrystallization was performed under a non-oxidizing atmosphere, the first oxide film layer and the second oxide film layer have the thicknesses comparable to each other. In contrast to this, in Comparative Example 2 in which an oxide film was formed while performing nanocrystallization, and Comparative Example 4 in which the oxide film forming step was not performed, and the nanocrystallization was also performed under a non-oxidizing atmosphere, the first oxide film layer had a thickness equal to or larger than twice that of the second oxide film layer.

In Comparative Example 4, since an oxide film was not intentionally formed, the oxide film layer formed on the ribbon surface was that caused by natural oxidation. For this reason, the total thickness of the two oxide film layers of Comparative Example 4 was less than 5 nm, and was considerably thinner than the total thickness of the first oxide film layer and the second oxide film layer of Example 2 in which an oxide film was formed intentionally.

### [Measurement of Depth Profile by XPS Analysis]

From each Fe-based nanocrystalline alloy magnetic core obtained in Example 2, Comparative Example 2, and Comparative Example 4, a ribbon in the second region (l₁/l₂/l₃=45/10/45) was cut out to give a sample X. Of both the surfaces of the sample X, the surface opposed to the outer circumferential surface when the ribbon was wound to form the magnetic core was assumed to be the analysis surface. The analysis surface was subjected to XPS analysis while being sputtered to acquire the depth profile. The XPS analysis conditions are as follows. The results are shown in FIGS. 5 to 7. In FIGS. 5 to 7, the horizontal axis in the chart of the XPS analysis was set as the depth in terms of SiO₂ (nm) calculated using the sputter etching rate of the SiO₂ standard sample from the sputtering time.

### (XPS Analysis Conditions)

Device: PHI 5000 Versa Probe (provided by ULVAC-PHI, Inc.)
Ultimate pressure: 6.7×10⁻⁸ Pa or less
Excitation source: monochrome Al-Kα X ray
Output: 25 W
Detected area: 100 μmφ
Angle of incidence: 45°
Take-off angle: 45°
(Sputtering conditions)
Ion species: argon
Acceleration voltage: 1 kV
Sweep area: 2 mm×2 mm
Sputtering rate: 2.27 nm/min

As indicated from FIG. 5, with the depth profile of Example 2, the peak (maximum value) of Cu₂ₚ was observed in the vicinity of a depth of 2.27 nm corresponding to the first oxide film layer, and it has been indicated that the intensity of the peak of Cu₂ₚ is stronger than the intensity of the peak of O_{1S} derived from SiO₂ within the depth range corresponding to the first oxide film layer. Further, with the depth profile of Example 2, the peaks of O_{1S} and Si₂ₚ derived from SiO₂ were observed in the vicinity of a depth of 11.35 nm corresponding to the second oxide film layer, and it has been indicated that the intensity of the peak of O_{1S} derived from SiO₂ is stronger than the intensity of the peak of Cu₂ₚ within the depth range corresponding to the second oxide film layer. Further, the intensity of the peak of Cup within the depth range corresponding to the first oxide film layer was stronger than the intensity of the peak of Cu₂ₚ within the depth range corresponding to the base material.

On the other hand, with the depth profiles of Comparative Example 2 and Comparative Example 4, the intensity of the peak of Cu₂ₚ became the maximum value within the depth range corresponding to that between the second oxide film layer and the base material, and was weak within the depth range corresponding to the base material and further weak within the depth range corresponding to the first oxide film layer. Further, with the depth profile of Comparative Example 2, the peaks of O_{1S} and Si₂ₚ derived from SiO₂ were observed in the vicinity of a depth of 9.08 nm corresponding to the second oxide film layer. Whereas, with the depth profile of Comparative Example 4, the peaks of O_{1S} and Si₂ₚ derived from SiO₂ were observed in the vicinity of a depth of 2.27 nm corresponding to the first oxide film layer.

### REFERENCE SIGNS LIST

10 Fe-based nanocrystalline alloy magnetic core

11 Inner circumferential surface

12 Outer circumferential surface

21 First region

22 Second region

23 Third region

1. A method for producing a Fe-based nanocrystalline alloy magnetic core, the method comprising:
subjecting a magnetic core material in which a ribbon of a nanocrystallizable Fe-based alloy is wound to heat treatment under an oxidizing atmosphere to form an oxide film; and
subjecting the magnetic core material that underwent the oxide film formation to heat treatment under a non-oxidizing atmosphere to perform nanocrystallization of the nanocrystallizable Fe-based alloy, wherein
the highest temperature of the heat treatment under the oxidizing atmosphere is a temperature lower than a crystallization start temperature of the nanocrystallizable Fe-based alloy, and
the highest temperature of the heat treatment under the non-oxidizing atmosphere is a temperature equal to or higher than the crystallization start temperature of the nanocrystallizable Fe-based alloy.

2. The method for producing the Fe-based nanocrystalline alloy magnetic core according to claim 1, further comprising:
applying the magnetic core material that underwent the nanocrystallization with a magnetic field in a height direction of the magnetic core material while subjecting the magnetic core material to heat treatment, wherein
the highest temperature of the heat treatment at the applied magnetic field is a temperature lower than the crystallization start temperature of the nanocrystallizable Fe-based alloy.

3. The method for producing the Fe-based nanocrystalline alloy magnetic core according to claim 1, wherein
the nanocrystallizable Fe-based alloy has a composition represented by the following general formula (I):
FeₓSiₐB_{b}Cu_{c}Nbₐ (I)
(in the general formula (I), a to d (at %) represent 3.0≤a≤12.0, 1.0≤b≤7.0, 1.0≤c≤5.0, and 1.0≤d≤9.0, respectively; and x (at %) is the balance other than Si, B, Cu, and Nb, and satisfies 73.0≤x≤92.0).

4. A Fe-based nanocrystalline alloy magnetic core comprising a wound body of a ribbon, wherein
the ribbon has a first oxide film layer, a second oxide film layer, and a base material formed of a Fe-based nanocrystalline alloy comprising an amorphous phase and a crystal grain, in this order,
the Fe-based nanocrystalline alloy has a composition represented by the following general formula (I), and
a depth profile by an X-ray photoelectron spectroscopy of a sample X shown below satisfies the following (A) and (B),
FeₓSiₐB_{b}Cu_{c}Nbₐ (I)
(in the general formula (I), a to d (at %) represent 3.0≤a≤12.0, 1.0 <b≤7.0, 1.0≤c≤5.0, and 1.0≤d≤9.0, respectively; and x (at %) is the balance other than Si, B, Cu, and Nb, and satisfies 73.0 ≤x ≤92.0)
(A) a peak of Cu₂ₚ appears within a depth range corresponding to the first oxide film layer; and
(B) within a depth range corresponding to the first oxide film layer, an intensity of the peak of Cu₂ₚ is stronger than an intensity of a peak of O_{1S} derived from SiO₂, wherein
(sample X) when a part between an inner circumferential surface and an outer circumferential surface of the Fe-based nanocrystalline alloy magnetic core is virtually divided into 3 regions of a first region, a second region, and a third region from the inner circumferential surface toward the outer circumferential surface, a ribbon situated in the second region is cut out, resulting in a sample; the first region, the second region, and the third region are regions that divide a radial length between the inner circumferential surface and the outer circumferential surface into 40/20/40; and an X-ray photoelectron spectroscopic analysis is performed on a surface of the sample that is opposed to the outer circumferential surface when the ribbon was wound to form the Fe-based nanocrystalline alloy magnetic core.

5. The Fe-based nanocrystalline alloy magnetic core according to claim 4, the depth profile further satisfies the following (C) and (D),
(C) peaks of O_{1S} and Si₂ₚ derived from SiO₂ appear within a depth range corresponding to the second oxide film layer, and
(D) within a depth range corresponding to the second oxide film layer, an intensity of a peak of O_{1S} derived from SiO₂ is stronger than the intensity of a peak of Cu₂ₚ.

6. The Fe-based nanocrystalline alloy magnetic core according to claim 4, the depth profile further satisfies the following (E),
(E) the intensity of a peak of Cu₂ₚ within a depth range corresponding to the first oxide film layer is stronger than the intensity of a peak of Cu₂ₚ within a depth range corresponding to the base material.

7. The method for producing the Fe-based nanocrystalline alloy magnetic core according to claim 2, wherein
the nanocrystallizable Fe-based alloy has a composition represented by the following general formula (I):
FeₓSiₐB_{b}Cu_{c}Nbₐ (I)
(in the general formula (I), a to d (at %) represent 3.0≤a≤12.0, 1.0 <b≤7.0, 1.0≤c≤5.0, and 1.0 <d≤9.0, respectively; and x (at %) is the balance other than Si, B, Cu, and Nb, and satisfies 73.0≤x≤92.0).

8. The Fe-based nanocrystalline alloy magnetic core according to claim 5, the depth profile further satisfies the following (E),
(E) the intensity of a peak of Cu₂ₚ within a depth range corresponding to the first oxide film layer is stronger than the intensity of a peak of Cu₂ₚ within a depth range corresponding to the base material.
